(19) United States
(12) Patent Application Publication
(10) Pub. No.: US 2003/0020893 A1
(43) Pub. Date: Jan. 30, 2003

(54) Exposure apparatus and method, and device fabricating method

(76) Inventor: Haruna Kawashima, Tochigi (JP)

Correspondence Address: MORGAN & FINNEGAN, L.L.P., 345 PARK AVENUE, NEW YORK, NY, 10154, US

(21) Appl. No.: 10/186,055

(22) Filed: Jun. 28, 2002

(30) Foreign Application Priority Data
Jul. 4, 2001 (JP) 203177/2001 (PAT.

(51) Int. Cl. G03B 27/42

(52) U.S. Cl. 355/67; 355/53; 353/71

(57) ABSTRACT

An exposure apparatus includes a projection optical system for projecting a pattern created on a mask onto an object, the projection optical system having a numerical aperture on a side of the object is 0.7 or higher; and a shielding plate for shielding around an area onto which the pattern on the mask is projected at the time of projection.

### BACKGROUND OF THE INVENTION

The present invention relates generally to exposure apparatuses, and more particularly to an exposure apparatus and method used to fabricate various devices such as single crystal plates for semiconductor wafers, glass plates for liquid crystal displays (LCD), and the like, a device fabricating method, and a device fabricated from an exposed object or target. The present invention is suitable, for example, for a projection exposure apparatus for projecting and exposing an object using a projection optical system that has a comparatively high numerical aperture in a photolithography process.

The fabrication of a device using the lithography technique has employed a projection exposure apparatus that uses a projection optical system to project a circuit pattern formed on a mask or reticle (these terms are used interchangeably in this application) onto a wafer and the like, thereby transferring the circuit pattern. The projection optical system enables diffracted light from the circuit pattern to interfere on the wafer and the like, so as to form an image.

A projection exposure apparatus uses, e.g., a step-and-repeat, or step-and-scan manner of an exposure mode to expose a target object. A step-and-repeat exposure apparatus, which is also referred to as a stepper, employs an exposure method that moves a wafer stepwise to an exposure area for the next shot every shot of cell projection onto the wafer. A step-and-scan exposure apparatus, which is also called a scanner, uses another mode of exposure method which exposes a mask pattern onto a wafer by continuously scanning the wafer relative to the mask, and by moving, after a shot of exposure, the wafer stepwise to the next exposure area to be shot.

The resolution R of a projection exposure apparatus is given in the following equation:

R=k₁ (λ/NA) (1)

where λ is a wavelength of a light source, and NA is a numerical aperture of a projection optical system. A recent demand for highly integrated devices has increasingly required minute patterns to be transferred or high resolution. The above equation shows that the higher numerical aperture NA and reduced wavelength λ would be effective for the higher resolution. Thus, in recent years, a light source has been in transition from the conventional ultrahigh pressure mercury lamp to a KrF excimer laser (with a wavelength of approximately 248 nm) and an ArF excimer laser (with a wavelength of approximately 193 nm) both having shorter wavelengths. The NA for the stepper projection optical system that uses the Krf excimer laser for a light source is 0.65, and the NA for a scanner projection optical system that uses the Krf and ArF excimer laser for a light source is 0.68 to 0.7. An F₂ excimer laser (with a wavelength of about 157 nm) is about to be put to practical use of a light source in the near future, and a development of a scanner is also required which installs a projection optical system with the NA of 0.8 to 0.85.

However, even when the NA of a projection optical system is made larger for higher resolution, the desired resolution cannot be obtained disadvantageously and, for example, each shot have a different size of a pattern transferred to a wafer by tens of nm. As a result of diligent studies of the cause, the present inventor has discovered that this problem results from flare light. Flare light, as used herein, generally refers to light other than desired diffracted light, which arrives at the wafer as a result of multiple reflections at various places.

Diffracted light that has passed through a mask pattern includes light of a high order, such as the third and fourth order light, etc., that do not contribute to the imaging of a desired pattern. Diffracted light of the high order reflects on lens's peripheral surface or round edge inside the projection optical system, a metal surface in a lens barrel, etc., subsequently the wafer surface, and the last plane of the projection optical system, thus finally becoming flare light that arrives at the non-exposure area on the wafer (namely, areas other than that currently being exposed). The 0-order and ±1-order diffracted light for use with exposure may also become flare light after reflecting on the wafer surface and the last plane of the projection optical system.

The present inventor has discovered that if the projection optical system has such a relatively small NA as about 0.7 or lower, influence of the flare light can be neglected because both the wafer surface and the last plane of the projection optical system have the low reflectance, whereas if the projection optical system has such a comparatively large NA as about 0.7 or higher, it cannot be since both the wafer surface and the last plane of the projection optical system have the high reflectance. For example, when multiple adjacent shots are exposed on the wafer, an amount of the flare light for each shot will be amplified. As a result, each shot has a different size of a transferred pattern in the order of tens of nm, whereby the desired resolution is hard to be obtained.

### BRIEF SUMMARY OF THE INVENTION

Accordingly, it is an exemplified object of the present invention to provide a (projection) exposure apparatus and method, a device fabricating method that will realize desired resolution even when a projection optical system has such a high NA as about 0.7 or higher.

An exposure apparatus as one aspect of the present invention includes a projection optical system for projecting a pattern of a mask onto an object, the projection optical system having a numerical aperture on a side of the object is 0.7 or higher, and a shielding member, disposed at an object side of the projection optical system, for shielding around an area onto which the pattern of the mask is projected at the time of the projection. The shielding member may be made of a material that reflects or absorbs the light. The exposure apparatus may have a step-and-scan exposure mode, and the shielding member may be fixed onto the projection optical system. The exposure apparatus may have a step-and-repeat exposure mode.

An exposure apparatus as another aspect of the present invention includes a projection optical system for projecting a pattern of a mask onto an object, and a light shielding member for shielding reflected light produced at an area onto which the pattern is projected, from entering surrounding of the exposed area. Such an exposure apparatus can prevent flare light from arriving at the object since the shielding plate or mechanism covers surrounding of the area currently being exposed. The projection optical system may have a numerical aperture on a side of the object is 0.7 or higher.

The shielding member may have an opening for exposing the object, and the exposure apparatus may further include a device for changing a size of the opening. The shielding member may be configured to be movable relative to the object. The exposure apparatus may have an illumination system for illuminating the mask, which illumination system may include a masking blade which restricts an exposure area on the object.

An exposure apparatus includes a projection optical system for projecting a pattern created on a mask onto an object, the projection optical system having a numerical aperture on a side of the object is 0.7 or higher, and a light shielding mechanism for shielding reflected light from reflecting on a surface of the projection optical system closest to the object and entering the object at the time of the projection, the reflected light resulting from light that is incident upon the object and corresponds to the numerical aperture of 0.7 or higher. The projection optical system may include a transparent plane parallel plate at its side closest to the object.

An exposure method as another aspect of the present invention includes the steps of projecting a pattern of a mask onto an object by using an projection optical system whose numerical aperture is 0.7 or higher, and controlling an arrangement of a shielding member arranged between the object and the projection optical system while determining a shielding area on the shielding member for shielding around an exposed area on the object.

A device fabricating method as still another aspect of the present invention includes the steps of projecting an object by using the above exposure apparatus and performing a specified process for the exposed object. Claims for a device fabricating method for performing operations similar to that of the above exposure apparatus cover devices as intermediate and final products. Such devices include semiconductor chips like an LSI and VLSI, CCDs, LCDs, magnetic sensors, thin film magnetic heads, and the like.

Other objects and further features of the present invention will become readily apparent from the following description of the preferred embodiments with reference to accompanying drawings.

### BRIEF DESCRIPTION OF THE DRAWINGS

FIG. 1 is a schematic sectional view of an exposure apparatus as one aspect of the present invention.

FIG. 2 is a schematic sectional view near the plate of the exposure apparatus shown in FIG. 1.

FIG. 3 is a schematic plan view showing the relationship between flare light and the transfer area when the exposure apparatus shown in FIG. 1 is used.

FIG. 4 is another schematic plan view showing the relationship between the flare light and the transfer area when the exposure apparatus shown in FIG. 1 is used.

FIG. 5 is a schematic plan view showing an example of the shielding plate shown in FIG. 1.

FIG. 6 is a schematic plan view showing a variation of the shielding plate shown in FIG. 5.

FIG. 7 is a schematic plan view showing another variation of the shielding plate shown in FIG. 5.

FIG. 8 is a schematic sectional view near the image plane in the third embodiment according to the present invention.

FIG. 9 is a graph showing the reflection property of the surface of the plate shown in FIG. 1 relative to the incident angle of exposure light.

FIG. 10 is a graph showing the reflection property of the last plane of the projection optical system relative to the incident angle of exposure light.

FIG. 11 is a flowchart for explaining automatic adjusting of an opening of the shielding plate which the inventive exposure apparatus includes.

FIG. 12 is a detailed flowchart for Step 106 shown in FIG. 11.

FIG. 13 is a flowchart for explaining a device fabricating method that includes the exposure steps of the present invention.

FIG. 14 is a flowchart for Step 4 shown in FIG. 13.

### DETAILED DESCRIPTION OF THE PREFERRED EMBODIMENTS

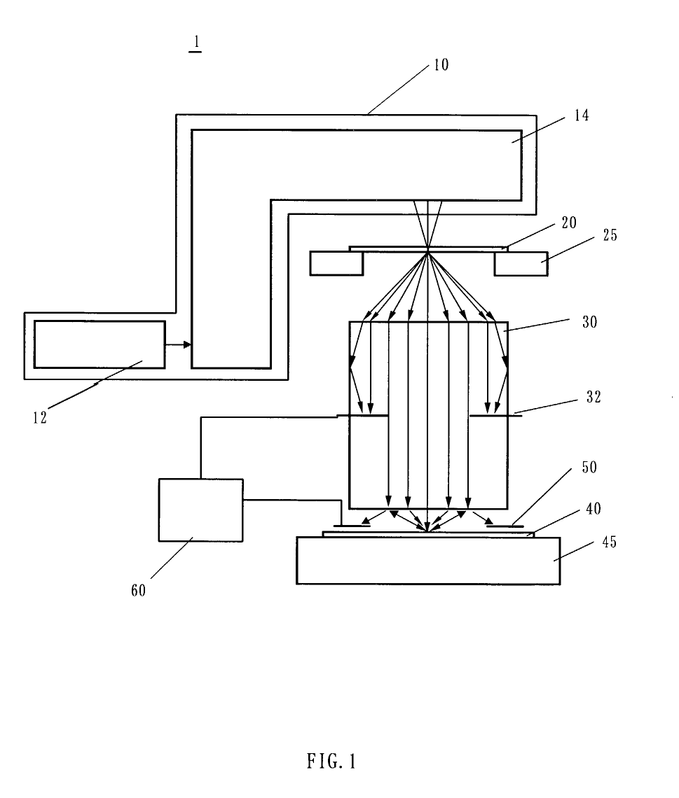

Referring to the accompanying drawings, a description will now be given of an exposure apparatus 1 according to the present invention. Here, FIG. 1 is a schematic sectional view of the exposure apparatus 1 of the present invention. As shown in FIG. 1, the exposure apparatus 1 includes an illumination apparatus 10, a mask 20, a mask stage 25, a projection optical system 30 having a numerical aperture of 0.7 or higher (at a side of a wafer plane), a plate 40, a plate stage 45, a shielding plate 50 for shielding flare light, and a controller 60 for controlling the opening and driving of the shielding plate 50. The exposure apparatus 1 according to this embodiment is a projection exposure apparatus of a step-and-scan type, which exposes a circuit pattern created on the mask 20 onto the plate 40. However, the present invention can be applied to a step-and-repeat manner and other exposure manners.

The illumination apparatus 10 illuminates the mask 20 on which a circuit pattern to be transferred is formed, thus including a light source section 12 and an illumination optical system 14.

The light source section 12 employs, for example, laser as a light source. Laser to be used is an ArF excimer laser, a KrF excimer laser, an F₂ excimer laser, etc. A kind of laser is not limited to the excimer laser. For example, a YAG laser can be used, and the number of laser units is not limited. When laser is used for the light source section, it is preferable to use a beam shaping system for reshaping a parallel beam from the laser into a desired one, and an incoherently turning optical system for turning a coherent laser beam into an incoherent one. Moreover, the light source to be used for the light source 12 is not limited to the laser, and it can be a lamp such as one or a plurality of mercury lamps or xenon lamps.

The illumination optical system 14 is an optical system that illuminates the mask 20, thus including lenses, mirrors, light integrators, stops, etc., for example, arranged in the order of a condenser lens, a fly-eye lens, an aperture stop, a condenser lens, a slit, and an image-forming optical system. The illumination optical system 14 can use any light regardless of whether it is on-axis light or off-axis light. The light integrator may include a fly-eye lens or an integrator formed by stacking two sets of cylindrical lens array plates (or lenticular lenses), but it may be replaced with an optical rod or a diffractive element. The illumination optical system 14 according to the present embodiment includes, as described later, a masking or scan blade for changing the size of the transfer area on the plate 40.

The mask 20 is made, for example, of quartz, on which a circuit pattern (or an image) to be transferred is formed, and is supported and driven by the mask stage 25. Diffracted light through the mask 20 is projected onto the plate 40 through the projection optical system 60. The plate 40 is an object to be exposed, onto which resist is applied. The mask 20 and plate 40 are located in a conjugate relationship. Since the exposure apparatus 1 according this embodiment is a scanner, it transfers a pattern on the mask 20 onto the plate 40 by scanning the mask 20 and plate 40. If the exposure apparatus 1 is a stepper, it exposes while resting the mask 20 and plate 40.

The mask stage 25 supports the mask 20, being connected to a transport mechanism (not shown). The mask stage 25 and the projection optical system 30 are provided on a stage lens barrel stool supported via a damper, for example, to the base-frame placed on the floor. The mask stage 25 can use any structure known in the art. The transport mechanism (not shown) is made of a linear motor and the like, and drives the mask stage 25 in X-Y directions, thus moving the mask 20. The exposure apparatus 1 scans the mask 20 and the plate 40 in a state synchronized by a control mechanism (not shown).

The projection optical system 30 has a NA (on the side of the plate 40) that has been set to be about 0.7 or higher, and attempts high resolution as described with reference to the equation 1. The projection optical system 30 includes an aperture stop 32 for forming a circuit pattern formed on the mask 20 onto the plate 40 from diffracted light that passes through the mask 20. The projection optical system 30 may use an optical system solely composed of a plurality of lens elements, an optical system comprised of a plurality of lens elements and at least one diffractive optical element such as a kinoform, and a full mirror type optical system, and so on. Any necessary correction of the chromatic aberration may use a plurality of lens units made from glass materials having different dispersion values (Abbe values), or arrange a diffractive optical element such that it disperses in a direction opposite to that of the lens unit. In general, the projection exposure apparatus uses partial coherent illumination of 0<σ<1. Coherency σ is a ratio between a numerical aperture (NA) at the mask side of the illumination optical system as opposed to the NA at the mask side of the projection optical system.

The aperture stop 32 is installed approximately at the pupil position in the projection optical system 30. The aperture stop 32 allows on-axis and off-axis light having the same NA within the exposure area in the projection optical system 30 to reach the image plane. The aperture stop 32 allows 0-order and/or ±1-order diffracted light from the circuit pattern on the mask 20 to interfere each other on the plate 40. The diffracted light of a high order (2-order, 3-order, etc.) that do not participate in the imaging of the desired pattern may reflect on the inner surface in the lens barrel in the projection optical system 30, and pass through the aperture stop 32, thus possibly generating flare light described later. The aperture stop 32 serves to shield flare light generated from diffracted light and prevent it from reach the plate 40. The flare light results from the diffracted light from the circuit pattern on the mask 20 that reflects on the round edges in the projection optical system 30 and further reflects on the inner surface in the lens barrel in the projection optical system 30. The opening of the aperture stop 32 according this embodiment is structured to be variable by a drive mechanism (not shown) through the controller 60. The aperture shape of the aperture stop 32 is circular, and the size of the circular aperture is made variable.

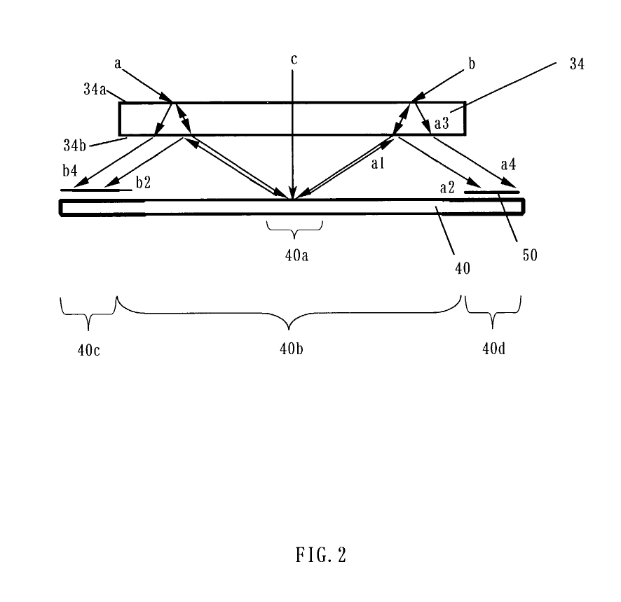

FIG. 2 is a partially enlarged sectional view of a shielding plate 50 near the projection optical system 30 and the plate 40 in the exposure apparatus 1. A seal glass 34 is a plane transmitting member installed at the last plane (namely, at the side of the plate 40 plane) of the projection optical system 30. The seal glass 34 is effective in adjusting and improving aberration of the projection optical system 30, and in purging the projection optical system 30 from the stage space. There are several ways for practical aberration adjustments, including controlling the spherical aberration by the thickness of the seal glass 34, controlling astigmatism by the tilt of the seal glass 34 relative to incident light, controlling coma aberration by using two seal glasses 34 while changing them slightly, etc. For example, residual aberration that remains in a projection lens (not shown) in the projection optical system 30 may be eliminated by processing the thickness of two seal glasses 34, then eliminating remaining astigmatism by tilting the two seal glasses 34 in the same direction, and finally, eliminating the coma aberration by changing the relative tilt of the two seal glasses.

For example, the exposure apparatus 1 that uses the F₂ excimer laser with a wavelength of about 153 nm for the light source section 12 needs to fill up all the space for the light path, such as not only the inside of the projection optical system 30 but also the stage space, with gas, such as N₂ or He, which has less light absorption, since absorption of light with a wavelength of 153 nm in the air drops drastically. In addition, when excimer laser is used for the light source section 12, a very small amount of resist sublimes due to its strong light energy, and thus it may possibly become deposited on the last plane of the projection optical system 30 (namely, on the side of the plate 40 plane). If a deposit amount of the sublimated resist is very small, it may not affect the transmittance and reflectance of the projection optical system 30, whereas as the deposit increases it will. A change in transmittance causes non-uniform illumination of the exposure area, while a change in reflectance causes increased flare light. The adverse effect of the deposition may be avoided by providing an exchangeable seal glass 34 at the last plane of the projection optical system 34 (namely, the side of the plate 40 plane).

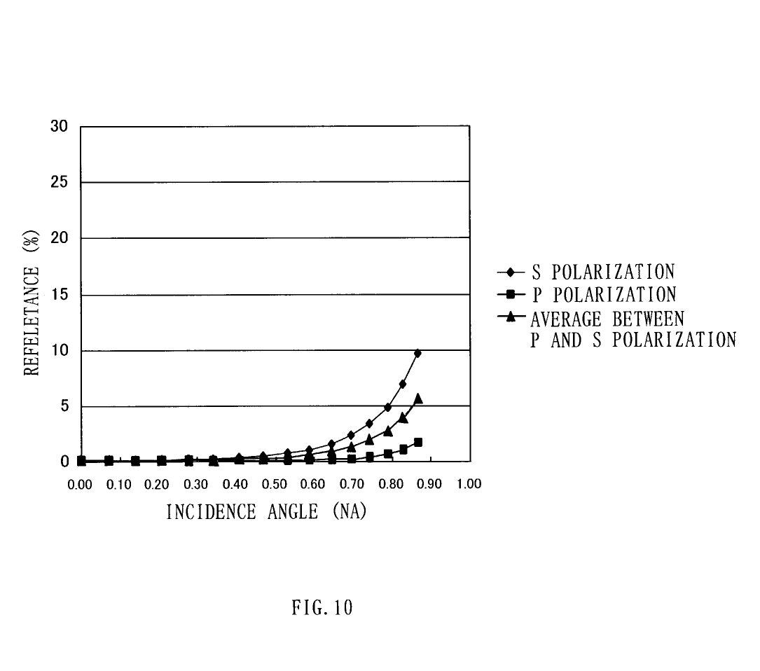

FIG. 10 shows an anti-reflection property of the last plane of the projection optical system 30. In this figure, the horizontal axis is the NA of the projection optical system 30 as an incident angle of exposure light incident upon the plate 40, while the vertical axis is the reflectance at the last plane of the projection optical system 30. FIG. 10 shows a reflection property of p polarization in a plane in which an oscillatory direction includes incident light and a normal direction, a reflection property of s polarization in a plane perpendicular to the plane in which an oscillatory direction includes the incident light and the normal direction, and an average reflection property between the p and s polarizations.

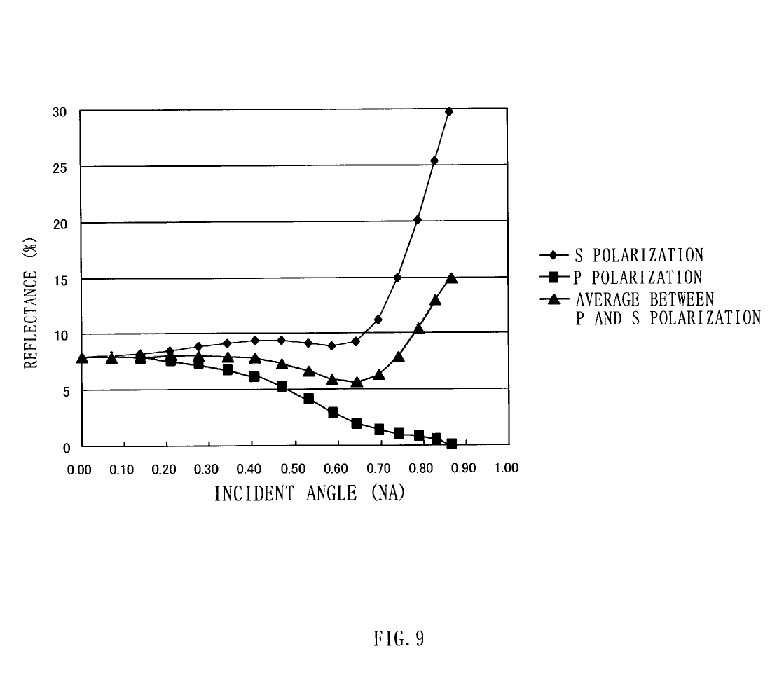

Anti-reflection coating applied to the last plane of the projection optical system 30 adopts a structure of a multi-layer film, thus obtaining far better anti-reflection effects compared to the anti-reflection property of the plate 40 (wafer) plane described later with reference to FIG. 9. The anti-reflection coating is designed such that each reflectance of the p and s polarizations becomes low even if the NA becomes large, but if NA becomes larger than 0.5, the reflectance of the p and s polarizations with gradually increase. It is understood that an average reflectance between the two reaches about 2% around NA=0.7 and over 5% around NA=0.85, thus the anti-reflection effect dropping significantly.

The plate 40 is a wafer in this embodiment, but it includes a wide range of objects to be exposed such as a liquid crystal plate and others. Photoresist is applied onto the plate 40. A photoresist application step includes a pretreatment, an adhesion accelerator application treatment, a photoresist application treatment, and a pre-bake treatment. The pretreatment includes cleaning, drying, etc. The adhesion accelerator application treatment is a surface reforming process so as to enhance the adhesion between the photo-resist and a base (i.e., a process to increase the hydrophobicity by applying a surface active agent), through a coat or vaporous process using an organic film such as HMDS (Hexamethyl-disilazane). The pre-bake treatment is a baking (or burning) step, softer than that after development, which removes the solvent.

In order to control reflection from the plate 40, a resist layer is applied onto the plate where an anti-reflection layer has been already applied. An application of an anti-reflection layer would make it possible to control the reflectance of both p and s polarizations (consequently, an average reflectance between the two) by less than 10% where the incident angle is vertical (i.e., the projection optical system's NA=0). Without an anti-reflection layer, a reflectance due to the thickness of the resist film would reflect in a range of several % to 40%.

FIG. 9 shows the reflectance property of the plate 40, onto which resist is applied after the anti-reflection layer has been applied to the plate, as described above. In this figure, the horizontal axis is the NA of the projection optical system as the incident angle of exposure light incident upon the wafer, while the vertical axis the reflectance on the wafer, thus showing, as FIG. 10, an average reflection property of the p and s polarizations.

Referring to FIG. 9, the reflectance of the p polarization begins to drop as NA exceeds about 0.3, and becomes as low as almost 0% around NA=0.85. In contrast, the reflectance of s polarization gradually continues to increase until the NA gets to nearly 0.6. It falls within less than 10%, then it suddenly goes up as NA slightly exceeds 0.6, and reaches about 30% around NA=0.85. As a result, around NA=0.6 to 0.7, the average reflectance between p and s polarizations becomes a little lower than that when NA=0, but when it is a little past NA=0.7 (approximately 7%), the reflectance rapidly goes up, reaching about 15% around NA=0.85. The reflection property shown in FIG. 9 varies to some extent in an incident angle in which reflection begins to increase depending on anti-reflection layer and resist thickness, but it does not affect the general situation of the discussion.

As understood from FIGS. 9 and 10, when the NA of the projection optical system 30 is about 0.7 or lower, the reflectance of the plate 40 (wafer) and the reflectance of the last plane of the projection optical system 30 (on the side of the plate 40) are comparatively low. This appears to be the reason why an adverse influence of flare light is small when the NA of the projection optical system 30 is around 0.7. However, past NA=0.7, the reflectances of the plate 40 plane and of the last plane of the projection optical system 30 are both more than about 6% and 2%, respectively, thus becoming comparatively high. Predictably, this increase in reflectance would lead to the non-negligible adverse influence of flare light in view of the future trend that increases the NA of a projection optical system (from about 0.7 to about 0.85).

The stage 45 supports the plate 45 and is connected to a transport mechanism (not shown). The stage 45 is installed on a stage stool supported on the floor and the like, for example, via a damper. The stage 45 may use any structure known in the art. The transport mechanism (not shown) may be made of a linear motor and the like, and drives the stage 45 in X-Y directions, thus moving the plate 40. As mentioned above, the exposure apparatus 1 according to this embodiment scans the plate 40 and the mask 20 in a state synchronized by a control mechanism (not shown).

The shielding plate 50 is provided between (the seal glass 34 of) the projection optical system 30 and the plate 40. An oblique-incident focus detecting system measures multiple points on a surface of the plate 40 so as to control the exposure shot's inclination and height. Therefore, it is preferable to provide the shielding plate 50 slightly away from the surface of the plate 40 to maintain the movement of the focus detecting system. The shielding plate 50 enables the plate 40 to be exposed, and shields part of the plate 40 other than that area currently being exposed. The shielding plate 50 does not hinder exposure light needed for the imaging of a desired pattern from reaching the plate 40, but hinders light unnecessary for the imaging of the desired pattern (i.e., flare light) from reaching the plate 40. The area currently being exposed means, for example, a slit-shaped scan area if a scanner is used, and one shot of an exposure area if a stepper is used.

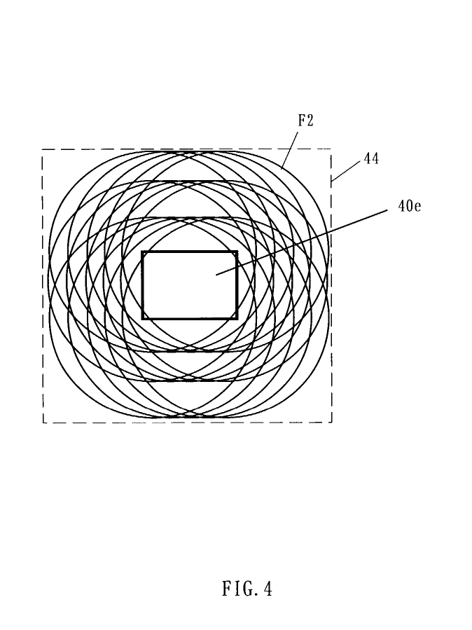

The shielding plate 50 attempts to prevent flare light from reaching the plate 40, and as described later, the flare light has a certain region for an exposure area. The region that the shielding plate 50 shields may not be the whole area other than that currently being exposed (i.e., the entire area of the plate 40), and it may be limited to an area where the flare light spreads or where the light intensity is especially strong. As shown in FIG. 4, which will be described later, the flare light may reach a currently being exposed area 40e (an area 40e₁, etc.). The shielding plate 50 does not necessarily have to prevent flare light completely from reaching the plate 40, but it is enough to reduce a ratio of reaching the plate 40.

The shielding plate 50 does not have to prevent all the flare light that may be possibly produced when the NA of the projection optical system 30 changes. In other words, the flare light drastically deteriorates resolution as the projection optical system 30 has the NA of 0.7 or higher. The shielding plate may be configured to mainly prevent such flare light from reaching the plate 40 when the NA of the projection optical system 30 is 0.7 or higher. When the NA of the projection optical system 30 is set to 0.8, this structure enables the shielding plate 50 to shield the flare light that is produced on the plate 40 where the projection optical system 30 has the NA between 0.7 and 0.8.

Referring to FIGS. 2 to 4, a description will now be given of a region that flare light spreads. Referring now to FIG. 2, there are shown light “a” that enters the upper left of the seal glass 34 with a large incident angle, refracts in a right direction within the seal glass 34, and then travels toward the center of the plate 40, and light “b” that enters the upper right of the seal glass 34 with a large incident angle, refracts in a left direction within the seal glass 34, and then, and travels toward the center of the plate 40. The light “a” and light “b” are, for example, ±1-order diffracted light of the diffracted light from the mask 20, which, as described later, reaches the plate 40, thus exposing (or transferring) a pattern created on the mask 20 onto the area 40a.

Part of the light “a” reaching the area 40a on the plate 40 reflects (as light “a1”) in an upper right direction on the plate 40, and then reflects at the bottom plane 34b of the seal glass 34, thus traveling to the plate 40 again as flare light a2. Part of the light “a1” is refracted into the inside of the seal glass 34, reflects (as light “a3”) on the top surface 34a of the seal glass 34, and then is refracted at the bottom surface 34b of the seal glass 34, thus traveling to the plate 40 again as flare light “a4”. There exists flare light that reflects on the surface of a lens (not shown) in the projection optical system 30, and returns to the plate 40, but a description thereof will be omitted. Similarly, part of the light “b” reaching the area 40a of the plate is directed to the plate 40 as flare light “b2” and “b4”. The principle discussed in FIG. 2 equally applies to diffracted light of a high order in the diffracted light from the mask 20.

Thus, it is noted that the region where the flare light occurs on the plate 40 is the areas 40c and 40d outside the area 40a that is currently being exposed. It is thus sufficient that the shielding plate 50 covers, for example, the areas 40c and 40d. The shielding plate 50 according to this embodiment is made, for example, of a light reflecting material such as stainless steel, aluminum, and the like so that it may disperse flare light in the surrounding space that has reached the areas 40c and 40d.

FIG. 2 shows that even if the area 40b on the plate 40 is not shielded, the plate 40 is not influenced at the area 40b by the flare light. Therefore, the shielding plate 50 does not necessarily have to shield the whole area outside of the area 40a on the plate 40. The area 40a is a scan area when a scanner is used, and it is an exposure area for one shot when a stepper is used.

Suppose, for example, that the projection optical system 30 has the NA of 0.7, and the distance from the bottom plane 34b of the seal glass 34 to the plate 40 is 15 mm. Then, a horizontal distance from the center of the area 40a to the positions where flare light “a2” and “b2” reach the plate 40 is ±24.9 mm. When the seal glass 34 has a thickness of 5 mm, a horizontal distance from the center of the area 40a to the positions where flare light “a4” and “b4” reach the plate 40 is about ±35 mm. Therefore, the region of the area 40c to be shielded may be set to about −23 mm to about −37 mm, and the region of the area 40d to be shielded may be set to about +23 mm to +37 mm.

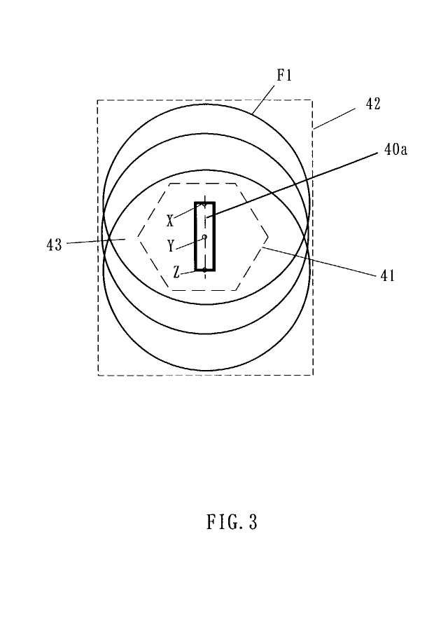

Since FIG. 2 is a section of the shielding plate 50 near the plate 40 of the exposure apparatus 1, a description has been given of light “a” and “b”, separately, but flare light appears annularly from one reflection point on the plate 40 as a diameter of 60 to 70 mm on the plate 40, as shown in FIGS. 3 and 4.

FIG. 3 is a typical partial plan view of the plate 40 viewed from the above. This figure shows a relationship between the transfer area 40a on the plate 40 and the region where flare light F1 spreads. The exposure apparatus 1 according to this embodiment scans and exposes a rectangular slit area 40a, which is 22 mm long by 5 mm wide. In other words, the area 40a is a scan area. Three circles (or rings) shown in this figure show a position of flare light F1 on the plate 40 (corresponding to “a2” and “b2” in FIG. 2). To make the description simple, only three kinds of flare light are shown that arise from the three points of the top central point X, central point Y and bottom central point Z. Circles showing respective flare light are circles centering around the point X, point Y, and point Z from top to bottom. FIG. 3 shows that annular flare light F1 has a large diameter relative to the transfer area 40a.

FIG. 4 is a typical partial plan view of the flare light F2 when the exposure apparatus 1 scans and exposes the rectangular slit area 40a shown in FIG. 3 for one shot in the direction of the slit width. The rectangular-shaped transfer area 40e shows a scan exposure area for one shot, and its size is 22 mm×35 mm. Many circles (or rings) mainly outside of the area 40e show positions of flare light F2 on the plate 40 (corresponding to “a2” and “b2” in FIG. 2). As shown in FIG. 4, flare light F2 appears much around the transfer area 40e, rather than inside of it, and the size of a pattern created on the mask 20, which is transferred when exposing it, may possibly change by tens of nm.

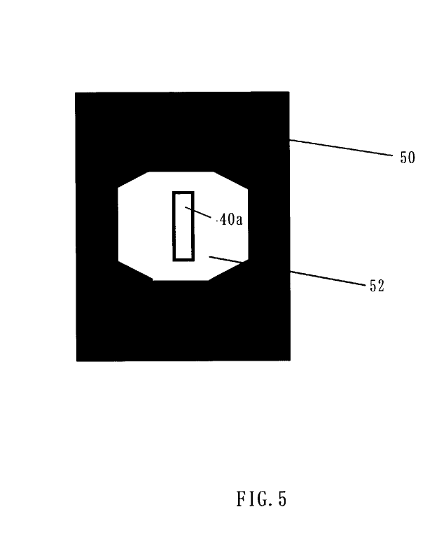

In order to shield the plate 40 from the region in which the flare light F1 shown in FIG. 3 exists, the flare plate 50 has a stop shape, for example, as shown in FIG. 5. Here, FIG. 5 is an exemplary plan view of the shielding plate 50. As an example, the external shape of the shielding plate 50 in FIG. 5 is similar to the outward dotted rectangle 42 shown in FIG. 3, and its size is equal to or a slightly larger than that of the rectangle 42. In another example, the external shape of the shielding plate 50 has an arbitrary shape that is larger than the rectangle 42. Since the shielding plate 50 does not have to completely shield the plate 40 from flare light as mentioned above, the external shape of the shielding plate 50 may be partially or wholly smaller than the rectangle 42.

The shielding plate 50 shown in FIG. 5 has a hexagonal opening 52. The opening 52 is similar to the inward dotted hexagon 41 shown in FIG. 3, and its size is preferably equal to or slightly larger than that of the hexagon 41. In FIG. 3, since the area 40a exists in the cat-eye area 43 formed by the circles centering around the point X and point Z, the shape of the opening 52 can take any arbitrary shape (a circle, rectangle, oval, and others) if it is an area that includes the area 40a, and is larger than the area 40a and smaller than the area 43. In addition, the opening 52 of the present embodiment is adapted to be variable by applying a variable mechanism, and the like, known in the art.

The sizes of the areas 41 and 42 need to be known when the shielding plate 50 is actually arranged and when the front of the plate 40 is not covered. Data on the areas 41 and 42 can be obtained by simulating parameters including, for example, the NA of the projection optical system 30, the thickness and refraction characteristic of the seal glass 34, the interval between the seal glass 34 and the plate 40, the interval between the shielding plate 50 and the plate 40, etc. As mentioned above, the present inventor has discovered from the simulation results that flare light that arises from one reflecting point on the plate 40 appears within a circular shape (or a ring shape), with a diameter of about 60 mm to 70 mm, centering around the point. It will be understood from this that the distance between the vertical side of the area 42 and the point Y may be set, for example, to about 35 mm or more.

In order to shield the plate 40 from the sphere where the flare light F2 shown in FIG. 4 exists, the shielding plate 50 may have, for example, a structure shown in FIG. 5, and move in synchronization with the plate 40, but it can be adapted such that its opening 52 has a rectangular shape equal to or a slightly larger than the area 40e, and its external shape is a rectangular shape equal to or a slightly larger than the rectangle 44 shown in FIG. 4. As mentioned earlier, the opening shape of the shielding plate 50 and its external shape in this case are not limited to these described above, and likewise, the size and arrangement of the shielding plate 50 are not limited to the above, either.

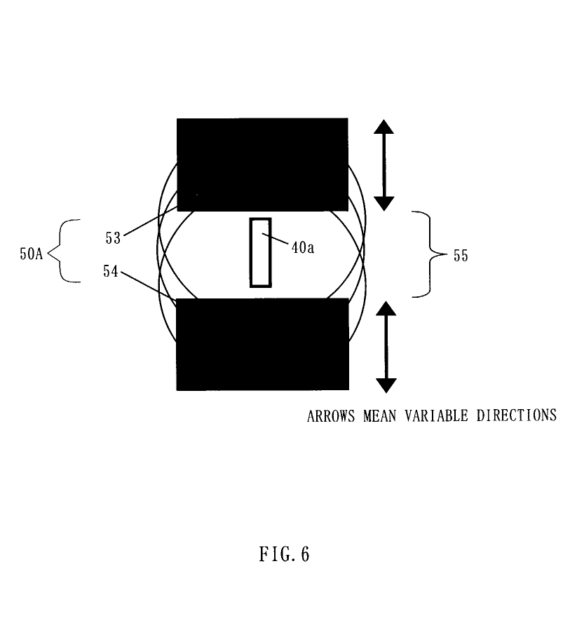

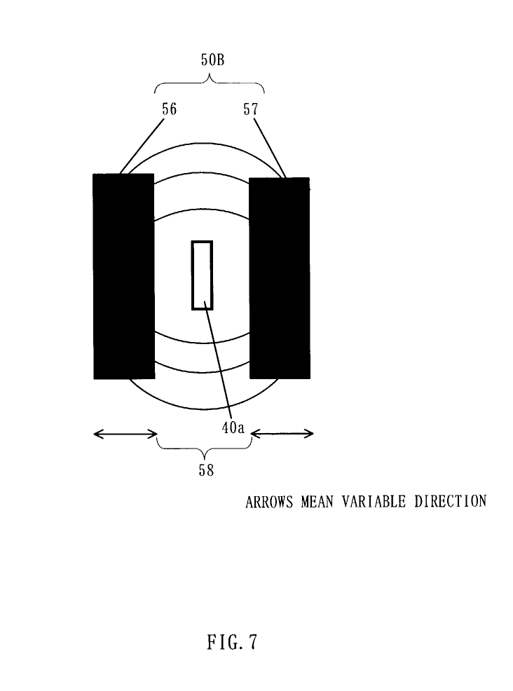

As described above, the shielding plate 50 may have various shapes, but it may be made up of multiple members of the same or different shapes and sizes. For example, as shown in FIG. 6, the shielding plate 50 may be replaced by the shielding plate 50A that is made up of two same shielding plates 53 and 54 separated in a vertical direction. Here, FIG. 6 is a schematic plan view of the shielding plate 50A. As shown in FIG. 7, the shielding plate 50 may be replaced by the shielding plate 50B that is made up of two same shielding plates 56 and 57 separated in a horizontal direction. Here, FIG. 7 is a schematic plan view of the shielding plate 50B. The shielding plate 50A shown in FIG. 6 shields the plate 40 from upper and lower parts of three circles that represent the flare light F1 shown in FIG. 3. The shielding plate 50B shown in FIG. 7 shields the plate 40 from right and left parts of three circles that represent the flare light F1 shown in FIG. 3. In addition, unless otherwise described, the shielding plate 50 generalizes the shielding plates 50A and 50B.

The shielding plates 53 and 54 each have a size of, for example, 30 mm×60 mm, and the interval 55 between the two is set to about 30 mm. The shielding plates 56 and 57 each have a size of, for example, 70 mm×15 mm, and the interval 58 between the two is set to about 30 mm. As mentioned above, these sizes and intervals are found by simulating the sphere where the flare light exists, and are determined by deciding how much of the sphere should be shielded.

The shielding plates 50A and 50B can easily adapt the intervals 55 and 58 to be variable by connecting the shielding plates 53 and/or 54, and the shielding plates 56 and/or 57 to a drive section not shown (e.g., a screw connected to a pulse-motor shaft). The intervals 55 and 58 correspond to the opening 52 shown in FIG. 5, and thus, may be interpreted as such. It is possible to make the opening 52 variable by using a variable stop and other mechanisms known in the art, but it would be far easier to use a mechanism that makes the intervals 55 and 58 variable.

The shielding plates 50A and 50B whose intervals 55 and 58 are built to be variable are preferable when the size of the transfer area is made variable. In other words, the exposure apparatus 1 according to this embodiment is constructed such that the rectangular slit area 40a shown in FIG. 3 is vertically variable. The vertical size of the transfer area 40a can be adapted variable by installing, for example, a stop in a position optically approximately conjugate with the plane of the mask 20 in the illumination optical system 14, the stop called a masking blade as described above, the width of whose opening is automatically variable. Further, the exposure apparatus 1 of this embodiment is constructed such that the rectangular slit area 40e shown in FIG. 4 is horizontally variable. The horizontal size of the transfer area 40e as a scanning exposure area for one shot can be adapted to be variable by installing a stop, in addition to making variable the scanning exposure length of the rectangular slit area 40, in a position optically approximately conjugate with the plane of the mask 20 in the illumination optical system 14, the stop called a scan blade similar to the above masking blade, the width of whose opening is automatically variable. Thus, the exposure apparatus 1 according to the present embodiment can use two kinds of variable blades to adjust the sizes of the transfer areas 40a and 40e in accordance with the size of an exposure shot.

Since the flare light that the shielding plate 50A attempts to shield against is for the rectangular slit area 40a shown in FIG. 3, the shielding plate 50A needs to alter the opening 55 when using the masking blade to change the vertical size of the transfer area 40a. But when the length of the transfer area 40e is to be changed in its scanning direction, the shielding plate 50B keeps the opening 58 as set for the rectangular slit area 40a shown in FIG. 3, with no need to change it in accordance with the opening width of the scan blade.

It is when the opening of the rectangular slit area 40a shown in FIG. 3 is made variable in the direction of the slit width that the shielding plate 50B needs to alter the opening 58. In this case, the shielding plate 50B is to alter the opening 58 in accordance with the alteration of the opening in the slit width direction.

It is preferable that the shielding plate 50 be fixed to the projection optical system 30 regardless of whether the exposure apparatus 1 is a stepper, or a scanner, the reason being that if not so, the shielding plate 50 must be separately driven in connection with the step-and-repeat operation in the stepper, while in the scanner, it needs a mechanism to drive it separately in sync with the scanning exposure operation. In fact, an installation of such a drive shielding plate on the stage not only adds to the weight of the stage, but causes dust, thus being a subject not to be admitted in general. However, the present invention does not preclude this. For moving the shielding plate 50, any technique known in the art can be applied, and thus, a detailed description of it is omitted here. Here, ‘fixed’ does not necessarily mean that the shielding plate 50 is fixed to the lens barrel, which is a component of the projection optical system 30, by using a screw and the like. For example, the shielding plate 50 is fixed, by using a screw, to a main body on which the stage 45 is mounted, and even if the body for mounting the stage 45 vibrates so as to eliminate reaction force accompanied by the driving of the stage 45, the shielding plate 50 is regarded as fixed, if the amount of vibration is too small to influence the shielding of flare light, and even if the shielding plate 50 is in motion as against the projection optical system 30.

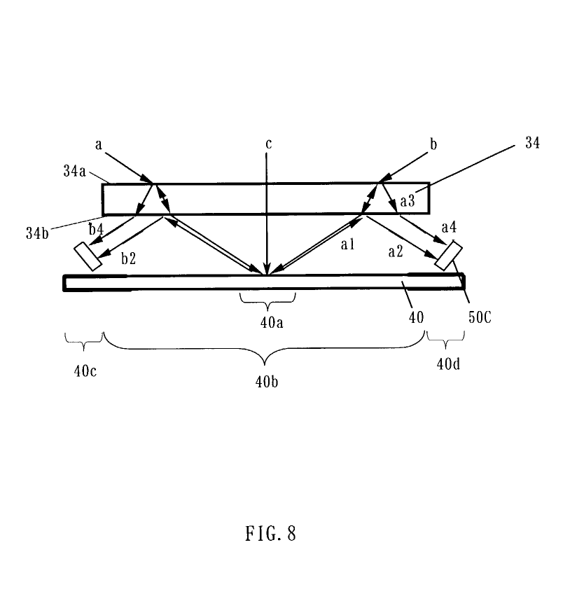

The shielding plate 50 shown in FIG. 2 is composed of a light reflecting material, and thus, it reflects flare light a2 and a4, and b2 and b4 on its surface into the surrounding space. However, there are structures in the surrounding space and thus, flare light a2, etc. reflected on the surface of the shielding plate 50 is possibly polarized again to the plate 40. Accordingly, if there are a number of structures, etc. in the space surrounding the plate 40, the shielding plate 50 may be replaced by a shielding plate 50C as shown in FIG. 8. Here, FIG. 8 is an enlarged sectional view of the shielding plate 50C corresponding to FIG. 2.

The shielding plate 50C has a plane on which flare light a2, etc. is desirably almost perpendicularly incident, and the plane is composed of a light absorbing material, so that it can absorb the flare light a2, etc. As a result, the flare a2, etc. can be prevented from entering the plate 40. In order for exposure light to have a light absorbing characteristic, glass may be used, onto whose incident plane an anti-reflection coat is applied. As glass, if a generic glass material is used such as one for a camera having a transmittance characteristic in a visible range, it will have a nearly complete light absorbing characteristic for light with a wavelength of 300 nm or less, thus being able to attain its objective. It is needless to say that if it is a substance having a light absorbing characteristic, it can be other materials than glass. A similar effect is obtained by applying to the surface of the shielding plate 50 shown in FIG. 2 a coating such as titanium oxide that has a light absorbing characteristic for the respective wavelengths of F₂ excimer laser, ArF excimer laser and KrF excimer laser. The reason why the absorbing plane is arranged approximately perpendicular to the flare light a2, etc. is to minimize the surface reflection. Since the shielding plate 50C may have an opening (not shown) that is not variable, it may be adapted such that part of the structure (e.g., the lens barrel of the projection optical system 30, etc.) is also used as the shielding plate 50.

The controller 60 is connected to the drive section (not shown) of the aperture stop 32 of the projection optical system 30 and the shielding plate 50, controls the drive section, and automatically adjusts the opening of the aperture stop 32 and the opening 52 (55 and 58) of the shielding plate 50 in accordance with the opening of the area 40a and the rectangular slit area 40a in the direction of the slit width.

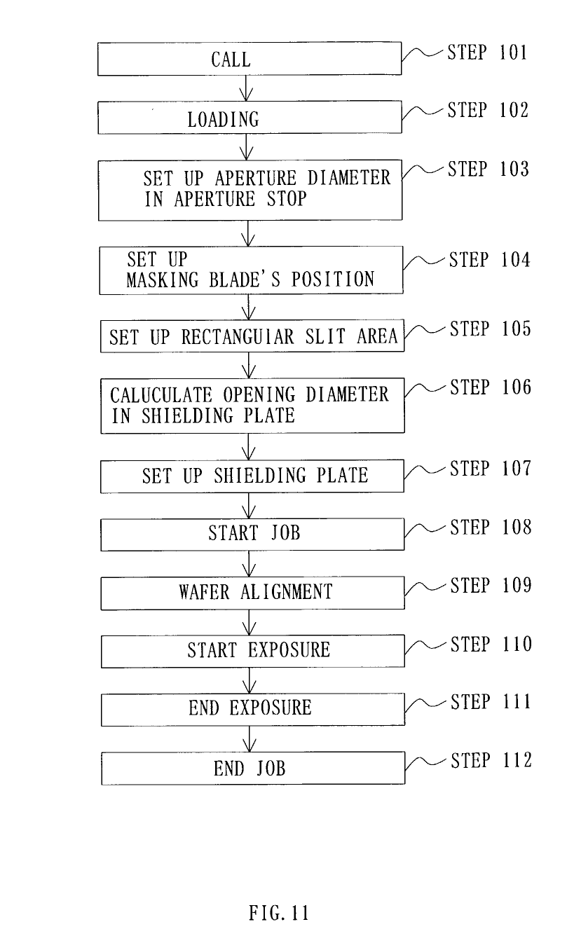

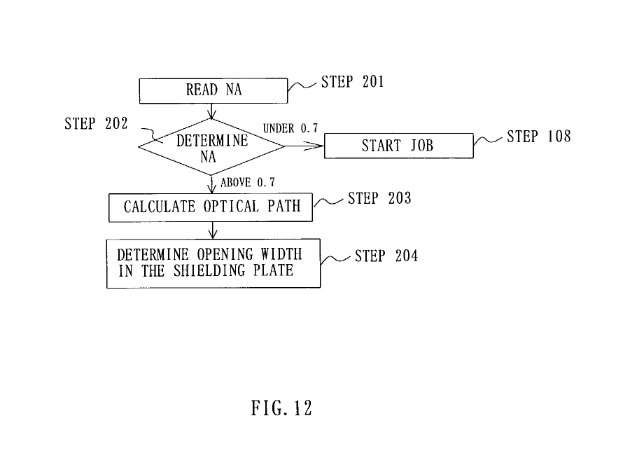

A description will now be given of the above automatic adjustment by referring to FIGS. 11 and 12. FIG. 11 is a flowchart for explaining how to automatically adjust the opening of the aperture stop 32 and the opening 52 (55 and 58) of the shielding plate 50 in accordance with the opening size of the rectangular slit 40a in the direction of the slit width.

Step 101 (calling) invokes a job from the exposure apparatus 1. Step 102 (loading) loads the mask 20 set for the job to the exposure apparatus 1. Step 103 (setting the diameter of the opening for the aperture stop) drives the diameter of the opening of the aperture stop 32 in accordance with the NA of the projection optical system 30 set for the job. Step 104 (setting the masking blade position) drives the opening of the masking blade in the illumination optical system 14 in accordance with masking blade position set for the job. Step 105 (setting the opening of the rectangular slit area) drives the opening in the direction of the slit width in accordance with the value of the slit width of the rectangular slit area 40a set for the job. Step 106 (calculating the diameter of the opening of the shielding plate) calculates the diameter of the opening 52 (55 and 58) of the shielding plate 50 based on the opening in the slit width direction of the rectangular slit area 40a set in Step 105. Step 107 (setting the shielding plate) drives the diameter of the opening 52 (55 and 58) of the shielding plate 50 so that it may be set to the diameter of the opening calculated in Step 106. Step 8 (starting the job) starts the job by using the exposure apparatus 1 set up in Steps 1 to 107. Step 109 (wafer alignment) aligns the wafer 40. Step 110 (starting exposure) starts the first shot of exposure. Step 111 (ending exposure) performs the last shot of exposure, and the job ends (at Step 112).

FIG. 12 is a detailed flowchart for calculating the diameter of the opening of the shielding plate (Step 106). Step 201 (reading in NA) reads in the NA of the projection optical system 30 set for the job. Step 202 (judging NA) judges whether the NA of the set projection optical system 30 is 0.7 or more (or less than 0.7). If the NA of the set projection optical system 30 is judged to be less than 0.7, the job is started (Step 108) without driving the shielding plate 50. If the NA of the set projection optical system 30 is judged to be 0.7 or more (in Step 202), the optical path for the beam of the NA (e.g., 0.8) of the set projection optical system 30 is calculated in Step 203 (calculating the optical path). Step 204 (determining the width of the opening of the shielding plate) determines the width of the opening of the shielding plate 50 from the optical path and the size in the slit width direction of the rectangular slit area 40a calculated in Step 203 (based on which information the opening of the masking blade is determined).

Information needed for the calculation of the optical path, for example, information on the distance between the plate 40 and the plane of the last lens in the projection optical system 30 is assumed to be stored in the console in advance. Further, in the example taken above, a thought was not given to a distribution state of the effective light source of the illumination optical system 14 for the job that exposes the plate 40 (σ value of illumination light, annular illumination and quadrupole illumination, etc.). In other words, the optical path calculation was performed on condition that an effective light source distribution is uniform, and σ value is 1.

However, in calculating the optical path, the distribution state of the effective light source of the illumination optical system 14 may be taken into consideration. After considering even information on a circuit pattern to be transferred to the plate 40 (such as the pattern's width, pitch, the pattern's rotational angle such as length, breadth or 45°, information on a pattern shape such as a line and hole, presence of a phase shifter, transmittance of the shielding part in the case of a half-tone mask, etc.), a rigorous calculation may be performed of the effective light source distribution of the illumination light and diffracted light produced from the pattern on the mask 20, thus calculating the optical path. In short, the controller 60 can change the opening 52 of the shielding plate 50 and the shielded area in compliance with the sphere where flare light is produced, thereby shielding the plate 40 from the flare light.

The controller 60 has a memory and a sensor (not shown), and controls the drive section for driving the shielding plate 50 according to the optimal size of the opening of the shielding plate 50 stored in advance in the memory in response to the transfer areas 40a and 40e. When the sensor detects that the opening 52 of the shielding plate 50 has become a prescribed size, the controller 60 stops the drive section from driving. The optimal size of the shielding plate 50's opening can be obtained by simulation as described. Further, if the distance between the seal glass 34 and the plate 40 becomes as short as 10 mm, that would shield the exposure light for the transfer areas 40a and 40e in the case of the shielding plate 50 where the size of the opening 52 is fixed, and therefore, the controller 60 should preferably control the size of the opening 52 of the shielding plate 50 considering the distance between the seal glass 34 and the plate 40.

At the time of exposure, the beam emitted from the light source section 12 of the illumination apparatus 10 enters the illumination optical system 14, which uniformly illuminates, e.g., Koehler-illuminates the mask 20. The beam that has passed through the mask 20 is demagnified and projected onto the plate 40 under a specified magnification by the image-forming operation of the projection optical system 30 whose NA is about 0.7 or more. Referring to FIG. 2, ±1-order diffracted light a and b and 0-order diffracted light c interfere on areas of the plate 40, thus transferring an image of the mask pattern. Since the NA of the projection optical system 30 is relatively large, as large as about 0.7, the pattern image is transferred to the plate 40 with high resolution as the equation 1 shows.

At such a transfer time, the shielding plate 50 shields the plate 40 from the flare light reflected between the plate 40 plane and the last plane of the projection optical system 30, thus preventing the resolution from being deteriorated.

Before initial exposure, at the end of each shot of exposure, and every time the size of the exposure area is changed by the illumination optical system 14, the controller 60 changes the opening 52 of the shielding plate 50 and the diameter of a circular opening (not shown) of the aperture stop 32 (as well as the exposed area). By do doing, the shielding plate 50 can prevent only flare light from entering the plate 40, without shielding exposure light necessary for image-forming the mask pattern. In this embodiment, the exposure apparatus 1 is a scanner, and the shielding plate 50 is fixed to the projection optical system 30, so that the plate 40 moves relative to the shielding plate 50.

According to such an operation, the exposure apparatus 1 can expose the whole plane of the plate 40 with desired resolution, thus providing high quality devices (such as semiconductor devices, LCD devices, image pick-up devices (such as CCDs), thin film magnetic heads, and the like).

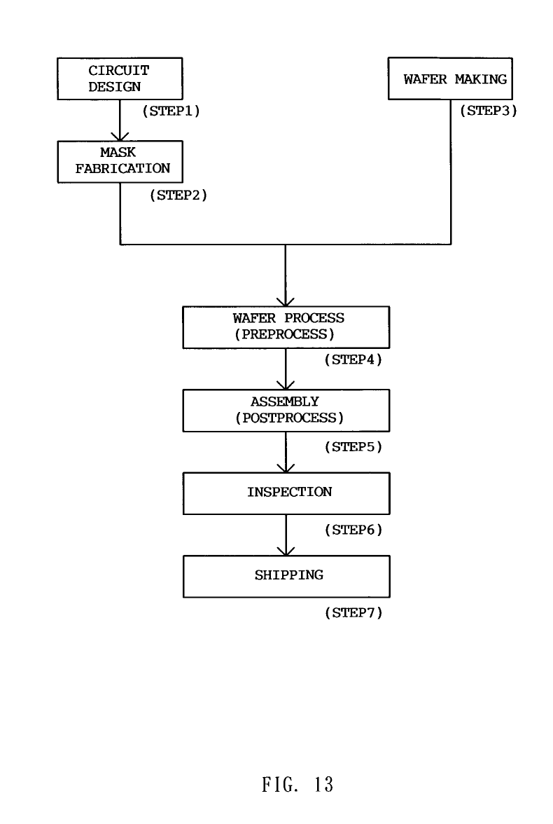

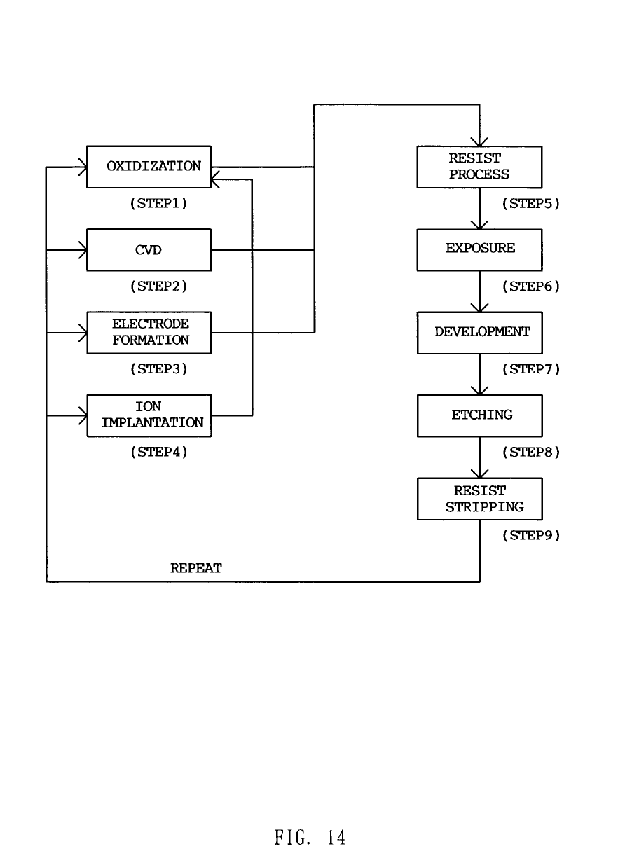

Referring to FIGS. 13 and 14, a description will now be given of an embodiment of a device fabricating method using the above mentioned exposure apparatus 1. FIG. 13 is a flowchart for explaining how to fabricate devices (i.e., semiconductor chips such as IC and LSI, LCDs, CCDs, etc.). Here, a description will be given of the fabrication of a semiconductor chip as an example. Step 1 (circuit design) designs a semiconductor device circuit. Step 2 (mask fabrication) forms a mask having a designed circuit pattern. Step 3 (wafer making) manufactures a wafer using materials such as silicon. Step 4 (wafer process), which is also referred to as a pretreatment, forms actual circuitry into a semiconductor chip using the mask and wafer, including an assembly step (e.g., dicing, bonding), a packaging step (chip sealing), etc. Step 6 (inspection) performs various tests for the semiconductor device made in Step 5, such as a validity, test and a durability test. Through these steps, a semiconductor device is finished and shipped (Step 7).

FIG. 14 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ion into the wafer. Step 15 (resist process) applies a photosensitive material onto the wafer. Step 16 (exposure) uses the exposure apparatus 1 to expose a circuit pattern on the mask onto the wafer. Step 17 (development) develops the exposed wafer. Step 18 (etching) etches parts other than a developed resist image. Step 19 (resist stripping) removes disused resist after etching. These steps are repeated, and multi-layer circuit patterns are formed on the wafer.

According to the present invention, it is possible to effectively eliminate (shield) flare light that is produced by the exposure light reflecting on the wafer's surface in the exposure apparatus on which a projection optical system having an NA of 0.7 or more is mounted. It is also possible to effectively eliminate the flare light that spreads into the surrounding space, and therefore, when multiple shots are exposed adjacently on the wafer, it is possible to eliminate a difference in size of a pattern to be transferred not only in the shot but also between shots, thus maintaining high resolution.

Further, the present invention is not limited to these preferred embodiments, and various variations and modifications may be made without departing from the scope of the present invention. For example, the present embodiments determine the shape, size and arrangement of the shielding plate 50 so that flare light produced may be prevented in accordance with the change of the NA of a projection optical system, but the shape, size, and arrangement of the shielding plate 50 may be determined so that flare light produced may be prevented according to the reflectance of the plate 40's surface and/or the reflectance of the last plane of the projection optical system.

Thus, the inventive exposure apparatus and method may easily and effectively remove flare light produced from exposure light reflected on a wafer, thus maintaining the high resolution. In addition, a device fabricating method employing such an exposure apparatus can provide high quality devices.

What is claimed is:

1. An exposure apparatus comprising:
a projection optical system for projecting a pattern of a mask onto an object, said projection optical system having a numerical aperture on a side of the object is 0.7 or higher; and
a shielding member, disposed at an object side of said projection optical system, for shielding around an area onto which the pattern of the mask is projected at the time of the projection.

2. An exposure apparatus comprising:
a projection optical system for projecting a pattern of a mask onto an object; and
a light shielding member for shielding reflected light produced at an area onto which the pattern is projected, from entering surrounding of the area.

3. An exposure apparatus according to claim 2, wherein said projection optical system has a numerical aperture on a side of the object is 0.7 or higher.

4. An exposure apparatus comprising:
a projection optical system for projecting a pattern created on a mask onto an object, said projection optical system having a numerical aperture on a side of the object is 0.7 or higher; and
a light shielding mechanism for shielding reflected light from reflecting on a surface of said projection optical system closest to the object and entering the object at the time of the projection, the reflected light resulting from light that is incident upon the object and corresponds to the numerical aperture of 0.7 or higher.

5. An exposure apparatus according to claim 4, wherein said projection optical system includes a transparent plane parallel plate at a side closest to the object.

6. An exposure apparatus according to claim 1, wherein said shielding member has an opening for exposing the object, and said exposure apparatus further comprises a device for changing a size of the opening.

7. An exposure apparatus according to claim 2, wherein said shielding member has an opening for exposing the object, and said exposure apparatus further comprises a device for changing a size of the opening.

8. An exposure apparatus according to claim 1, wherein said shielding member is configured to be movable relative to the object.

9. An exposure apparatus according to claim 2, wherein said shielding member is configured to be movable relative to the object.

10. An exposure apparatus according to claim 1, wherein said shielding member is made of a material that reflects the light.

11. An exposure apparatus according to claim 1, wherein said shielding member is made of a material that absorbs the light.

12. An exposure apparatus according to claim 1, wherein said exposure apparatus has a step-and-scan exposure mode, and said shielding member is fixed onto said projection optical system.

13. An exposure apparatus according to claim 1, wherein said exposure apparatus has a step and repeat exposure mode.

14. An exposure method comprising the steps of:
projecting a pattern of a mask onto an object by using an projection optical system whose numerical aperture is 0.7 or higher; and
controlling an arrangement of a shielding member arranged between the object and the projection optical system while determining a shielding area on the shielding member for shielding around an exposed area on the object.

15. A device fabricating method comprising the steps of:
projecting the object by using an exposure apparatus comprising a projection optical system for projecting a pattern of a mask onto an object, said projection optical system having a numerical aperture on a side of the object is 0.7 or higher, and a shielding member for shielding around an area onto which the pattern on the mask is projected at the time of projection; and
performing a predetermined process for the object exposed.

16. An exposure apparatus according to claim 1, wherein a masking blade which restricts an exposure area on the object is in a mask illumination system.

17. An exposure apparatus according to claim 2, wherein a masking blade which restricts an exposure area on the object is in a mask illumination system.
